(19) United States
(12) Patent Application Publication
(10) Pub. No.: US 2014/0185690 A1
(43) Pub. Date: Jul. 3, 2014

(54) MULTIMEDIA DATA STREAM FORMAT, METADATA GENERATOR, ENCODING METHOD, ENCODING SYSTEM, DECODING METHOD, AND DECODING SYSTEM

(71) Applicants: Sung-Wen WANG, Hsinchu Hsien (TW); Yi-Shin Tung, Hsinchu Hsien (TW); PIN-TING LIN, Hsinchu Hsien (TW)

(72) Inventors: Sung-Wen WANG, Hsinchu Hsien (TW); Yi-Shin Tung, Hsinchu Hsien (TW); PIN-TING LIN, Hsinchu Hsien (TW)

(73) Assignee: MStar Semiconductor, Inc., Hsinchu Hsien (TW)

(21) Appl. No.: 14/108,552

(22) Filed: Dec. 17, 2013

(30) Foreign Application Priority Data
Dec. 28, 2012 (TW) 101151007

(51) Int. Cl. H04N 19/20; H04N 19/44

(52) U.S. Cl. CPC H04N 19/00387; H04N 19/00533
USPC 375/240.25; 375/240.01

(57) ABSTRACT

By determining multimedia positioning frames, by generating a metadata according to address information of the multimedia positioning frames and the number of multimedia frames following each of the multimedia frames, and by relocating the multimedia frames following each of the multimedia frames, a data storage amount of the metadata can be reduced. Further, when a user wishes to view a specific multimedia frame of a specific time point, the specific multimedia at the specific time point can be decoded and played without having to complete download of all multimedia frames preceding the specific time point.

This application claims the benefit of Taiwan application Serial No. 101151007, filed Dec. 28, 2012, the subject matter of which is incorporated herein by reference.

### BACKGROUND OF THE INVENTION

1. Field of the Invention

The invention relates in general to a multimedia data stream format, a metadata generator, an encoding method, an encoding system, a decoding method and a decoding method, and more particularly to a multimedia data stream format, a metadata generator applying the multimedia data stream format, an encoding method and an encoding system applying the metadata generator, and a decoding method and a decoding system corresponding to the encoding method and the encoding system.

2. Description of the Related Art

When viewing a multimedia file implemented by progressive streaming online, a user is usually required to wait for an inevitable period of time for a system to finish downloading the complete multimedia file before being allowed to view the multimedia file. However, the waiting time increasingly lengthens as the size of multimedia files continues to grow, thus undesirably affecting the convenience and instantaneousness of online viewing.

An original format of a multimedia data stream includes an audio bitstream and a video bitstream. Both of the audio and video bitstreams are usually compressed and encoded to reduce a data transmission amount. In order to synchronously play corresponding audio and video after decoding the audio and video bitstreams, the audio and video bitstreams are fed into a multiplexer. The multiplexer places the corresponding audio and video at neighboring positions in the multimedia data stream and combines the audio and video into a data format. The data format is then demultiplexed and decompressed by a demultiplexer to obtain audio and video to be later played.

FIG. 1 shows a schematic diagram of a data format of a multimedia data stream MSD0 transmitted by progressive streaming. As shown in FIG. 1, the multimedia data stream MDS0 includes multiple multimedia frames F0, F1, . . . , F19, F20, F21, F22, . . . , and FN generated from an audio bitstream and a video bitstream processed by a multiplexer. The multimedia frames include multiple audio frames A0, A1, . . . , A19, A20, A21, A22, . . . , and AN (to be referred to as audio frames) and multiple video frames V0, V1, . . . , V19, V20, V21, V22, . . . , and VN (to be referred to as video frames) that are alternately arranged, where N is a positive integer. The audio frames and the video frames having the same numerical denotations are regarded as the same multimedia frame in the multimedia data stream MDS0, and are played at the same time point. For example, the multimedia frame 19 includes the paired audio frame A19 and video frame V19, which are played at the same time point when playing the multimedia data stream MDS0. Similarly, the multimedia frame 20 includes the paired audio frame A20 and video frame V29, which are played at the same time point when playing the multimedia data stream MDS0.

When decoding audio and video frames in a multimedia data stream by a back-end demultiplexer, a method of searching audio and video frames is facilitated based on the same size of all multimedia frames. That is, given that a starting point of a multimedia data stream and an arranged sequence of a target multimedia frame among all multimedia frames in a multimedia data stream are known, the target multimedia frame can be identified through sequential access. However, since the audio and video frames in the multimedia data stream MDS0 are generated through compression and encoding processes, sizes of data between not only the audio frames but also the video frames may be different. Hence, when searching for a target multimedia frame from the multimedia data stream MDS0, the target multimedia frame may not be correctly identified by using the above sequential access based on the starting point of the multimedia data stream MDS0 and an arranged sequence of the target multimedia frame among all multimedia frames in a multimedia data stream MDS0. To overcome such issue, a metadata MDT0 included in the multimedia data stream MDS0 is designed to record address information of the audio and video frame alternately arranged in the multimedia data stream MDS0. As such, instead of being affected by the size differences of the audio and video frames, a back-end demultiplexer is enabled to quickly retrieve the audio and video frames when decoding the audio and video frames. This method yet suffers from certain drawbacks. For example, the data size of the metadata MDT0 proportionally increases as the audio and video frames of the multimedia data stream MDS0 expands, such that the metadata MDT0 occupies a substantial data amount in the multimedia data stream MDS0.

When downloading and playing the audio and video frames having the data format of the multimedia data stream MDS0 in FIG. 1, in the multimedia data stream MDS0, assume that a time interval that a user wishes to view corresponds to the audio and video between the multimedia frames F19 and F21. Based on the above progressive streaming mechanism and the above sequential access for the multimedia data stream, it is known that, before the user is allowed to access and view the audio and video of the time interval corresponding to the multimedia frames F19 and F21, the address information of all the multimedia frames from F0 to F21 need to be sequentially accessed from the metadata MDT0 while also waiting for all the multimedia frames to be completely downloaded. During the process, in addition to the time-consuming process of waiting for the all the multimedia frames to be completely downloaded, the number of times and the time for sequentially accessing the metadata MDT0 are spent on an unneeded data interval. In an event that the audio and video desired by the user are close to an end of the multimedia data stream MDS0 having a large data amount (i.e., N in a large value), the above sequential access mechanism is quite inefficient as the user needs to wait for a lengthy period before accessing and playing a desired video clip.

### SUMMARY OF THE INVENTION

To solve an excessive data processing amount and a lengthy waiting period resulted by retrieving and downloading a multimedia data stream from the beginning of the multimedia data stream in the prior art, the invention is directed to a multimedia data format, a metadata generator, an encoding method, an encoding system, a decoding method and a decoding system.

The encoded multimedia data stream format comprises a plurality of multimedia positioning frames and a metadata used for storing a plurality of address information and number of multimedia frames stored in the user data region of the multimedia positioning frames. Each multimedia positioning frame comprises a basic multimedia frame and a user data region used for storing a plurality of multimedia frames following the basic multimedia frame in a multimedia data stream. And, the multimedia data stream is a progressive streaming data stream.

The multimedia data stream encoding system comprises a multiplexer, a metadata generator and a multimedia data encoder. The multiplexer performs bit interleaving on an audio bitstream and a video bitstream to generate a multimedia data stream. The metadata generator selects a plurality of multimedia frames in a multimedia data stream as a plurality of multimedia positioning frames, and generates a metadata according to address information of the multimedia positioning frames and numbers of multimedia frames between two successive multimedia positioning frames of the multimedia positioning frames. The multimedia data encoder relocates the multimedia frames between two successive neighboring multimedia positioning frames to a user data region of corresponding multimedia positioning frames according to the metadata to generate an encoded multimedia data stream. And, the multimedia data stream is a progressive streaming data stream.

The multimedia data stream decoding system for decoding a encoded multimedia data stream comprises a multimedia data stream decoder and a demultiplexer. The multimedia data stream decoder searches a metadata according to an instruction to find addresses and numbers of multimedia frames of at least one multimedia positioning frame, and retrieves at least one multimedia frames from the at least one multimedia positioning frame according to the addresses and numbers of multimedia frames. The demultiplexer performs bit interleaving on the at least one multimedia frames to generate a decoded audio bitstream and a decoded video bitstream.

### BRIEF DESCRIPTION OF THE DRAWINGS

FIG. 1 is a schematic diagram of a data format of a multimedia data stream implemented in coordination with progressive streaming.

FIG. 2 is a block diagram of a multimedia data stream playback system according to an embodiment of the present invention.

FIG. 3 is a block diagram of a metadata generator in FIG. 2 according to an embodiment.

FIG. 4 is a schematic diagram of a data format of a multimedia data stream implemented in coordination with progressive streaming according to an embodiment of the present invention.

FIG. 5 is a schematic diagram of retrieving multimedia frames stored in each multimedia positioning frame by use of an additional LUT stored in a user data region of each multimedia positioning frame according to an embodiment of the present invention and the data format in FIG. 4.

FIG. 6 is a flowchart of an encoding method according to an embodiment of the present invention.

FIG. 7 is a flowchart of a decoding method according to an embodiment of the present invention.

### DETAILED DESCRIPTION OF THE INVENTION

To solve an excessive data processing amount and a lengthy waiting period in the prior art, in the present invention, a plurality of multimedia positioning frames are designated in a multimedia data stream, and all multimedia frames between two successive neighboring multimedia positioning frames are relocated to a user data region. Thus, a metadata is required to store only address information of the multimedia positioning frames and the number of multimedia frames placed in the user data region, and the multimedia positioning frame as well as the multimedia frames included in the multimedia positioning frame to be downloaded and played can be quickly retrieved through the metadata. Therefore, in addition to solving the issue of having to wait for all multimedia frames preceding the multimedia positioning frame to be completely downloaded before playing an appointed multimedia frame, the appointed multimedia frame can be quickly and efficiently played.

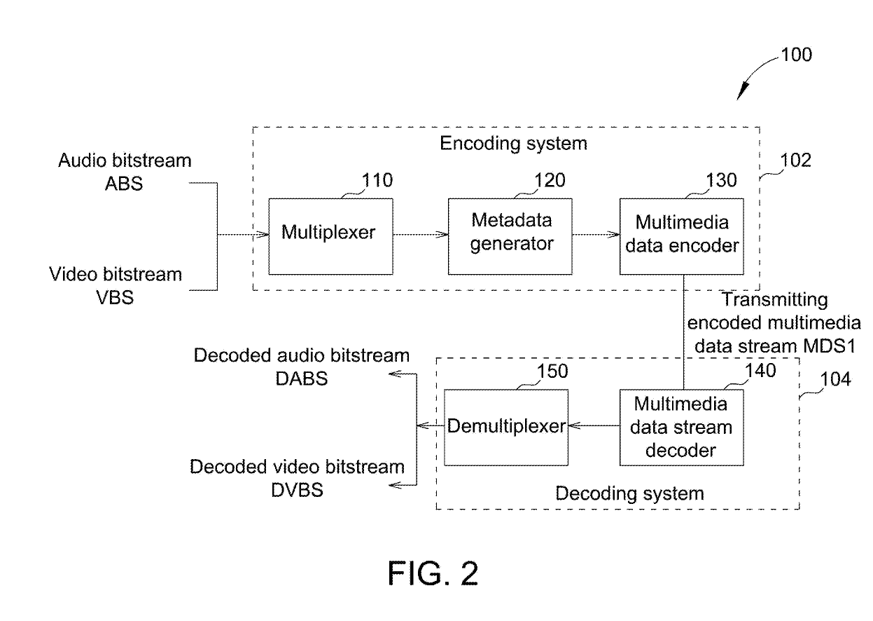

FIG. 2 shows a block diagram of a multimedia data stream playback system 100 according to an embodiment of the present invention. As shown in FIG. 2, the multimedia data stream playback system 100 comprises an encoding system 102 and a decoding system 104. The encoding system 102 encodes an audio bitstream ABS and a video bitstream VBS to generate an encoded multimedia data stream MDS1, and transmits the encoded multimedia data stream MDS1 to the decoding system 104 through wire or wireless transmission means such as the Internet or the telecommunication system. After receiving the encoded multimedia data stream MDS1, the decoding system 104 decodes required multimedia frames according to a time point appointed by a user instruction to generate a decoded audio bitstream DABS and a decoded video bitstream DVBS for playback.

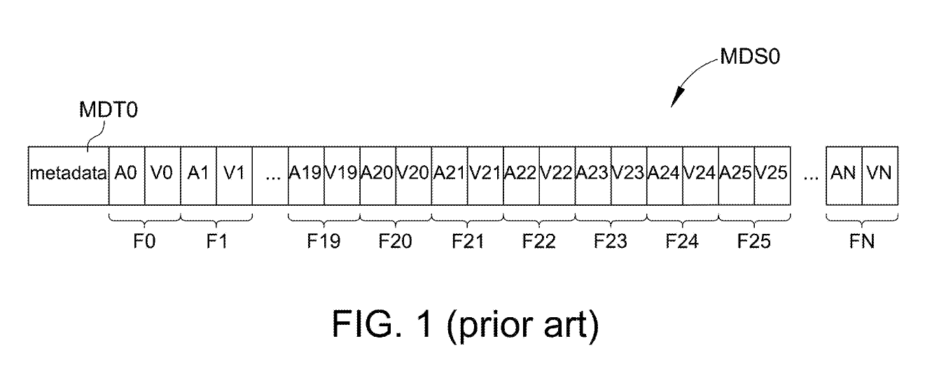

The encoding system 102 comprises a multiplexer 110 and a metadata generator 120. The multiplexer 110 performs bit interleaving on the audio bitstream ABS and the video bitstream VBS to generate a plurality of multimedia frames F0, F1, . . . , F19, F20, F21, F22, F23, F24, F25, . . . , and FN (to be referred to as multimedia streams) shown in FIG. 1, in a way that audio and video at close time points in the audio bitstream ABS and the video bitstream VBS can be placed at neighboring positions for synchronous playback.

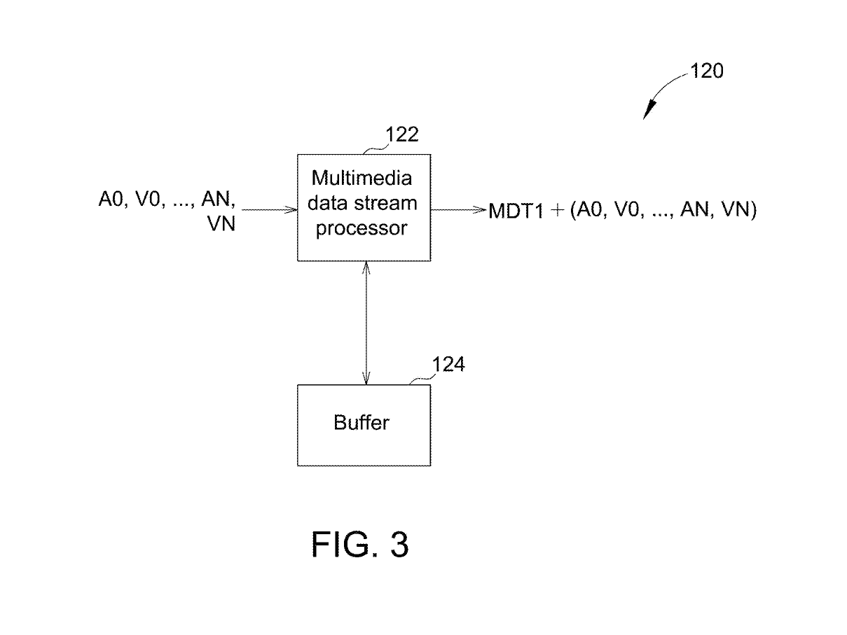

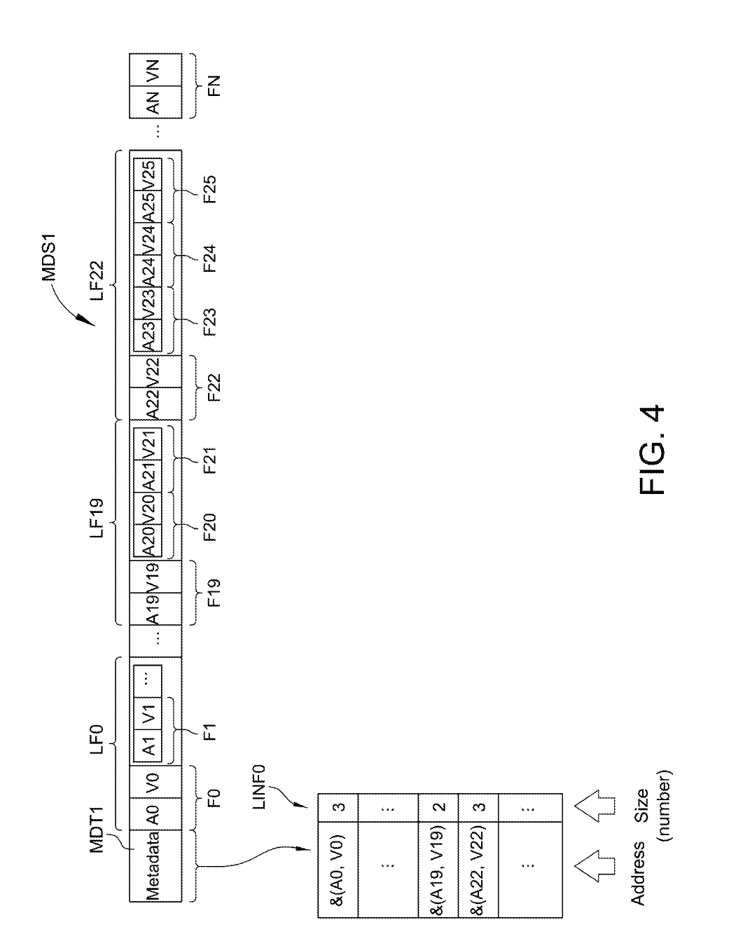

The metadata generator 120 selects a part of the multimedia frames as a plurality of multimedia positioning frames, and generates a metadata MDT1 according to the multimedia positioning frames and information between two successive multimedia positioning frames. Details for generating the metadata MDS1 are to be described shortly. FIG. 3 shows a block diagram of the metadata generator 120 according to an embodiment of the present invention. FIG. 4 shows a schematic diagram of a data format of the multimedia data stream MDS1 implemented by progressive streaming according to an embodiment of the present invention.

As shown in FIG. 3, the metadata generator 120 comprises a multimedia data stream processor 122 and a buffer 124. The multimedia data stream processor 122 and the buffer 124 generate the metadata MDT1 shown in FIG. 4. Further, the multimedia data stream processor 122 and the buffer 124 relocate all multimedia frames between two successive multimedia positioning frames according to the metadata MDT1 to a earlier multimedia positioning frames of the two successive multimedia positioning frames to substantially generate the multimedia positioning frames and to accordingly generate an encoded multimedia data stream MDS1.

Details for generating the multimedia data stream MDS1 are as described below. It is assumed that the multimedia data frames F0, F19 and F22 are basic multimedia frames respectively comprised in the multimedia positioning frames to be appointed by the metadata generator 120. When the metadata generator 120 receives the multimedia frames from the multiplexer 110, the metadata generator 120 first determines a plurality of multimedia frames (at least comprising the multimedia frames F0, F19 and F22) as the basic multimedia frames for the multimedia positioning frames, and generates the metadata MDT1 according to address information (e.g., numerical orders or addresses of the multimedia frames) of the multimedia positioning frames in the encoded multimedia data stream MDS1 and the number of multimedia frames between two successive multimedia positioning frames.

Referring to FIG. 4, as shown by a plurality of sets of records in a look-up table (LUT) LINFO stored in the metadata MDT1, each set of record includes an address of one multimedia positioning frame and the number of multimedia frames comprised in the multimedia positioning frame. For example, the multimedia frame F19 is appointed as a basic multimedia frame for a multimedia positioning frame LF19, and the multimedia frame F22 is appointed as a basic multimedia frame for a multimedia positioning frame LF22. And the multimedia positioning frame LF19 also comprises the multimedia frames F20 and F21, i.e., all of the multimedia frames between the multimedia positioning frame F19 and the multimedia positioning frame F21. Thus, the record associated with the multimedia positioning frame LF19 in the LUT LINFO stored in the metadata MDT1 indicates the address & (A19, V19) of the multimedia positioning frame LF19 and 2 as the number of multimedia frames comprised. Similarly, for the multimedia frame F0 appointed as a basic multimedia frame for a multimedia positioning frame LF0, the LUT LINFO in the metadata MDT1 records the address & (A0, V0) of the multimedia positioning frame LF0 and 3 as the number of the multimedia frames comprised (it is assumed that the multimedia positioning frame LF0 comprises multimedia frames F1, F2 and F3). Further, for the multimedia frame F22 appointed as a basic multimedia frame for a multimedia positioning frame LF22, the metadata MDT1 comprises the information of the address &(A22, V22) of the multimedia positioning frame LF22 and the number of the multimedia frames comprised (it is assumed that the multimedia positioning frame LF22 comprises multimedia frames F23, F24 and F25, and so the value in the number column of the multimedia frame corresponding to the multimedia positioning frame L22 is 3).

In the above process of generating the metadata MDT1, the multimedia data stream processor 122 performs operations of selection on the multimedia positioning frames and determination of the positioning information and the number of multimedia frames comprised, whereas the buffer 124 is for buffering the above operations. In an alternative embodiment of the present invention, instead of the composition shown in FIG. 3, the metadata generator 120 may also be a single element capable of performing functions of the multimedia data stream processor 122 and the buffer 124.

After generating the metadata MDT1, the metadata generator 120 transmits the multimedia frames F0, . . . and FN as well as the metadata MDT1 to the multimedia data encoder 130. According to the metadata MDT1, the multimedia data encoder 130 relocates multimedia frames into a corresponding multimedia positioning frame to substantially generate a multimedia positioning frame. For example, according to the planning record (&(A19, V19), 2) corresponding to the multimedia positioning frame LF19 in the LUT LINFO in the metadata MDT1, the multimedia data encoder 130 relocates the multimedia frames F20 and F21 to a user data region UDR19 of the multimedia frame F19 to substantially generate the multimedia positioning frame LF19. Similarly, according to the planning record (&(A0, V0), 3) corresponding to the multimedia positioning frame LF0 in the LUT LINFO in the metadata MDT1, the multimedia data encoder 130 relocates the multimedia frames F1, F2 and F3 to a user data region UDR0 of the multimedia frame F0 to substantially generate the multimedia positioning frame LF0. Further, according to the planning record (&(A22, V22), 3) corresponding to the multimedia positioning frame LF22 in the LUT LINFO in the metadata MDT1, the multimedia data encoder 130 relocates the multimedia frames F23, F24 and F25 to a user data region UDR22 of the multimedia frame F22 to substantially generate the multimedia positioning frame LF22. The user data region is generally a region that a multimedia frame utilizes for storing trivial or insignificant information, and may thus be utilized for storing audio frames and video frames. After completing the above relocation of the multimedia frames, the multimedia data encoder 130 generates the encoded multimedia data stream MDS1 to complete the above encoding procedure. As shown in FIG. 4, the encoded multimedia data stream MDS1 comprises the metadata MDT1 and a plurality of multimedia positioning frames (at least comprising the multimedia positioning frames LF0, LF19 and LF22).

Comparing the encoded multimedia data stream MDS1 in FIG. 4 and the multimedia data stream MDS0 in FIG. 1, it is observed that the sizes of the multimedia frames in the two multimedia data streams are substantially equal as the original multimedia frames are only relocated to the corresponding multimedia positioning frames. However, since the metadata MDT1 preserves only the records in a number equal to the number of the multimedia positioning frames while the number of the multimedia positioning frames is far smaller than the number of all of the multimedia frames, the size of the metadata MDT1 is smaller than that of the metadata MDT0. More specifically, because the number of the multimedia positioning frames is far smaller than the number of the multimedia frames, the size of the metadata MDT1 is far smaller than the size of the metadata MDT0, such that the size of the encoded multimedia data stream MDS1 is also remarkably smaller than the size of the multimedia data stream MDS0.

Again referring to FIG. 2, the decoding system 104 comprises a multimedia data stream decoder 140 and a demultiplexer 150. The multimedia data stream decoder 140 decodes the encoded multimedia data MDS1 transmitted from the encoding system 102 according to a section appointed by a user instruction, so as to retrieve the multimedia frames originally stored in the multimedia positioning frames corresponding to the appointed section. The demultiplexer 150 performs bit interleaving on the multimedia positioning frames and the multimedia frames retrieved by the multimedia data stream decoder 140 to generate a decoded audio bitstream and a decoded video bitstream for playback.

Operation details of the multimedia data stream decoder 140 are given with reference to the data format shown in FIG. 4. It is assumed that, a user wishes to view all audio and video starting from a time point of the multimedia frame F19 to the multimedia frame F21, and sends a corresponding user instruction to the decoding system 104. After receiving the encoded multimedia data stream, the multimedia data stream decoder 140 first reads the metadata MDT1, and identifies the address &(A19, V19) of the multimedia positioning frame LF19 and three as the number of multimedia frames comprised from the LUT LINFO according to the user instruction. The multimedia data stream decoder 140 then downloads the multimedia positioning frame LF19 according to the identified address and number of the multimedia frames, and retrieves the two multimedia frames F20 and F21 from the user data region UDR19 of the multimedia positioning frame LF19.

The demultiplexer 150 performs bit interleaving on the multimedia positioning frame LF19 and the multimedia frames F20 and F21 to obtain the corresponding decoded audio bitstream and decoded video bitstream after decoding, and forwards the decoded audio bitstream and decoded video bitstream to a subsequent module supporting a playback function to synchronously play audio and video according to the sequence of the multimedia positioning frame LF19, the multimedia frame F20 and the multimedia frame F21, thereby realizing the request of the user instruction. Compared to the prior art, the decoding system 104 offers at least the advantage below. To play audio and video of a predetermined time point appointed by a user, the decoding system 104, without having to wait for completely downloading all multimedia frames from a starting point of a multimedia data stream to a multimedia frame of the appointed location, is readily to perform playback after downloading and identifying the corresponding multimedia positioning frame and retrieving all the multimedia frames stored in the multimedia positioning frame from the user data region. In other words, a download data amount required for decoding in the present invention is smaller than that in the prior art, and the number of retrieval and time needed for playback are also less than the prior art. Thus, for a multimedia data stream having a colossal data amount or when playing audio and video corresponding to a later time point appointed by a user in a multimedia data stream, the advantage provided by the present invention becomes even more outstanding.

In the above embodiment, an example of retrieving one multimedia positioning frame is described. In an alternative embodiment, a user may also appoint a greater range that involves more than two consecutive multimedia positioning frames for playback. For example, the user instruction may instruct for playback of the multimedia frames F19 to F25. Accordingly, the decoding system 104 learns the information of the addresses and the numbers of multimedia frames stored in respective user data regions of the multimedia positioning frames LF19 and LF22, and readily starts the playback after retrieving the multimedia frames F19 to F25 and generating the corresponding audio and video bitstreams.

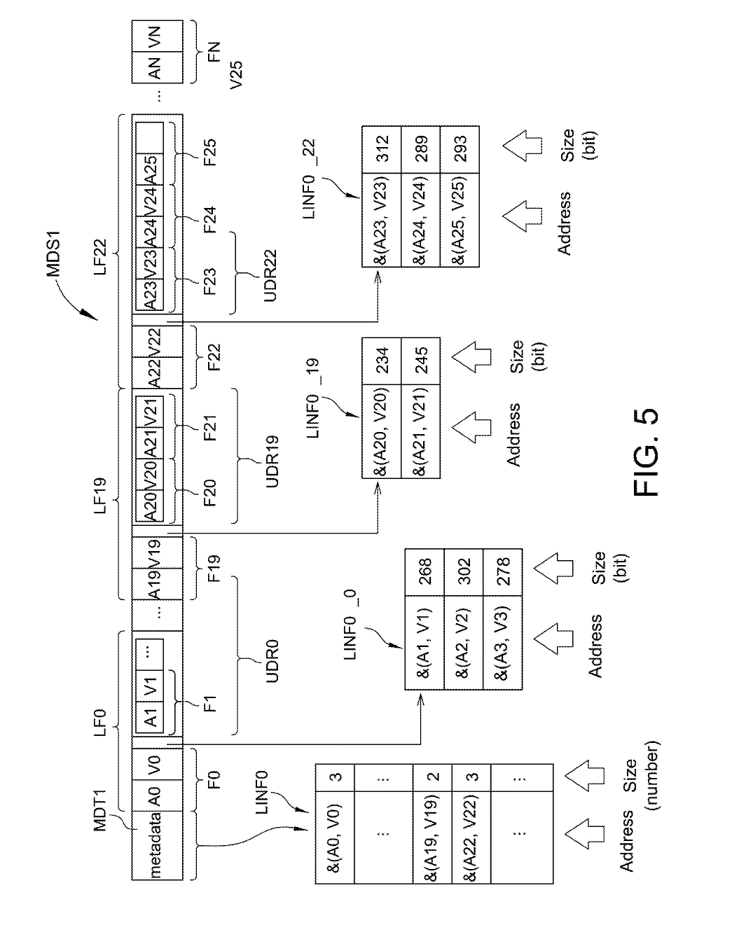

In an embodiment, the data format in FIG. 4 may additionally store another LUT in the user data region in each of the multimedia positioning frames, so as to provide a more accurate retrieval on the multimedia frames stored in the user data regions of the multimedia positioning frames. FIG. 5 shows a schematic diagram of retrieving the multimedia frames stored in each of the multimedia positioning frames by use of an additional LUT stored in the user data region of each of the multimedia positioning frames according to an embodiment of the present invention and the data format in FIG. 4.

As shown in FIG. 5, while generating the metadata MDT1, the metadata generator 120 may further generate an LUT (which is in equivalence generating another metadata) for each multimedia positioning frame to be generated to store the address and the bit count of each multimedia frame in the multimedia positioning frame, and merge the additional LUT into the user data region at the same time when substantially generating the multimedia positioning frame. For example, the metadata generator 120 may additionally generate an LUT LINFO_0 for the predetermined multimedia positioning frame LF0 to be generated, and an LUT LINFO_19 for the predetermined multimedia positioning frame LF19 to be generated. The metadata generator 120 may then store the LUT LINFO_0 to the user data region UDR0 at the same time when substantially generating the multimedia positioning frame LF0, and store the LUT LINFO_19 to the user data region UDR19 at the same time when substantially generating the multimedia positioning frame LF19.

When the multimedia data stream decoder 140 retrieves multimedia frames according to the user instruction, the user instruction may further appoint a specific multimedia frame in the multimedia positioning frame as a range of audio and video to be played. For example, assuming that the user instruction appoints the audio and video of the multimedia frames F20 to F24 for playback, in addition to identifying the addresses of and numbers of stored multimedia frames in the multimedia positioning frames LF19 and LF22 when looking up the LUT LINFO stored in the metadata MDT1, the multimedia data stream 140 further searches the LUTs LINFO_19 and LINFO_22 after completing the download of the multimedia positioning frames LF19 and LF22 to obtain the regional addresses and lengths of the multimedia frames F20, F21, F23 and F24. The multimedia data stream 140 then sequentially performs the retrieval, bit interleaving and playback operations of the multimedia frame F20, the multimedia frame F21, the multimedia positioning frame LF22, the multimedia frame F23 and the multimedia frame F24. As such, being not entirely limited by settings of time points of the multimedia positioning frames while enjoying the benefits brought by the data format in FIG. 4, a user is allowed to more precisely appoint the time point of the audio and video to be played.

In an embodiment of the present invention, the format of the multimedia frames or multimedia positioning frames comprised in the multimedia data stream is an MPEG-4 Part 14 (MP4) format, a Matroska Video File (MKV) format, or an audio format. The MP4 format as the frame format of the multimedia data stream is utilized as an example for explaining an embodiment of the present invention below.

In the MP4 format, all data (including multimedia data frame and metadata) are packaged in a unit of atoms. The multimedia data frames are defined by the type and data size and are stored in the corresponding metadata (referred to as a moov structure in the MP4 format), with the type and data size stored in the metadata being recorded in a fixed size of four bytes. A multimedia data frame in the MP4 format is referred to as a “chunk”, i.e., the multimedia frames F0, F19 and F22 shown in FIG. 4 or FIG. 5.

In the metadata of the MP4 format, an atom named as “STSZ” is included for recording the size of each multimedia frame. In the present invention, the atom STSZ is redesigned as the LUT LINFO in FIG. 4 or the LUT LINFO_0, LINFO_19 or LINFO_19 in FIG. 5. Accordingly, address information stored in the atom STSZ only need to comprise the address information of multimedia frames in a multimedia data stream instead of recording the address information of all multimedia frames, thereby significantly reducing the number of searching for decoding and the corresponding download time.

Further, as shown in FIG. 4 or FIG. 5, in the present invention, the multimedia frames in the multimedia data stream in the MP4 format are relocated to the user data region of the corresponding multimedia positioning frame, so that additional decoding burden or complications are not resulted when the multimedia data stream decoder 140 retrieves the multimedia frames from the user data region for decoding. On the other hand, when the present invention is implemented to a multimedia data stream in an H.264/AVC format, the multimedia frames may be stored as Supplemental Enhancement Information (SEI)/Network Abstraction Layer (NAL) types of information. However, a length of the bitstream may be changed due to additional encoding on multimedia packets before storing the multimedia packets such that relative addresses of the stored multimedia packets need to be repositioned, leading to an extremely time-consuming process and a vast amount of additional computation amount.

Details for processing an MP4 multimedia data stream by the decoding system 104 according to an embodiment are illustrated with reference to FIG. 5. After receiving the user instruction and determining the location of the appointed time point, the multimedia data stream decoder 140 identifies a location of a corresponding or approximate multimedia positioning frame from the metadata, and further decodes the required multimedia frames from the user data region in the downloaded multimedia positioning frame and plays the required multimedia frames.

Table-1 shows actual experimental data of implementing the method of the present invention to an MP4 multimedia data stream. In Table-1, the data are obtained through experiments based on a multimedia bit rate of 40 Kbps and a bit transmission rate of 80 Kbps utilized by Enhanced Data rates for GSM Evolution (EDGE). Contents of Table-1 are as follows.

TABLE 1

| | Original | | | Original | Download |
|---|---|---|---|---|---|
| | metadata | Data of | Reduction | download | waiting time |
| | (moov | present | in data | waiting | of present |
| Duration | format) | invention | amount | time | invention |
| (minutes) | (bytes) | (bytes) | (%) | (seconds) | (seconds) |
| 5 | 29246 | 4178 | 86% | 2.87 | 0.41 |
| 10 | 57831 | 7139 | 88% | 5.65 | 0.70 |
| 20 | 114611 | 12871 | 89% | 11.19 | 1.26 |
| 40 | 228231 | 24839 | 89% | 22.29 | 2.43 |
| 60 | 341847 | 36615 | 89% | 33.38 | 3.58 |

Table-2 shows actual experimental data of implementing the method of the present invention to an MP4 multimedia data stream. In Table-2, the data are obtained through experiments based on a multimedia bit rate of 20 Kbps and a bit transmission rate of 30 Kbps utilized by EDGE. Contents of Table-2 are as follows.

| | | | | | Download |
|---|---|---|---|---|---|
| | Original | | | Original | waiting |
| | metadata | Data of | Reduction | download | time of |
| | (moov | present | in data | waiting | present |
| Duration | format) | invention | amount | time | invention |
| (minutes) | (bytes) | (bytes) | (%) | (seconds) | (seconds) |
| 5 | 19572 | 3948 | 80% | 1.91 | 0.39 |
| 10 | 37665 | 6977 | 81% | 3.68 | 0.68 |
| 20 | 73853 | 12781 | 83% | 7.21 | 1.25 |
| 40 | 146161 | 23953 | 84% | 14.27 | 2.34 |
| 60 | 218525 | 35525 | 84% | 21.34 | 3.47 |

From the data in Table-1 and Table-2, it is clearly observed that, the present invention offers over 80% in reduction of data amount and over 75% of reduction in download waiting time.

In an embodiment of the present invention, the multimedia positioning frame may be implemented by a Key-frame (or an I-frame), and the multimedia frame relocated into the user data region of the multimedia positioning frame may be implemented by a predictive-frame (P-frame) in the multimedia data stream. Through the above encoding method, while subsequently decoding an encoded multimedia data stream, a user instruction may directly appoint a time point of an I-frame as a time point to be decoded and played. Further, the P-frame between the K-frames can be decoded to facilitate the playback of the K-frames and the P-frames.

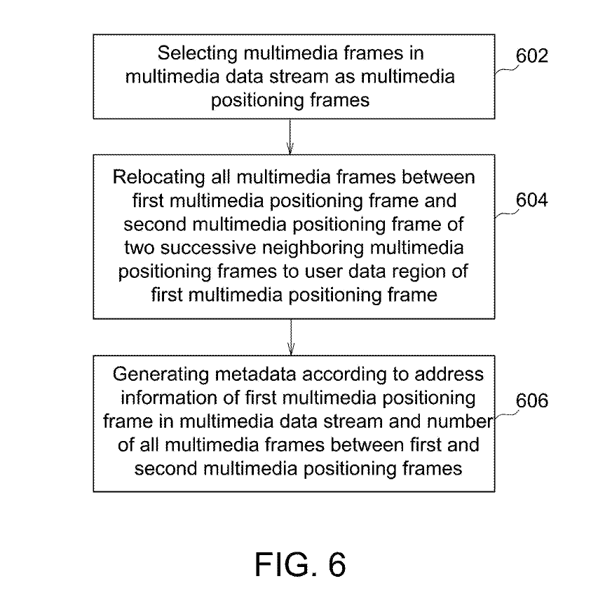

FIG. 6 shows a flowchart of an encoding method according to an embodiment of the present invention. The encoding method comprises the following steps.

In step S602, a plurality of multimedia frames in a multimedia data stream are selected as a plurality of multimedia positioning frames.

In step S604, all multimedia frames between two successive neighboring multimedia position frames, a first multimedia positioning frame and a second multimedia positioning frame, are relocated to a user data region of the first multimedia positioning frame.

In step S606, a metadata is generated according to address information of the first multimedia positioning frame in the multimedia data stream and the number of all the multimedia frames between the first multimedia positioning frame and the second multimedia positioning frame.

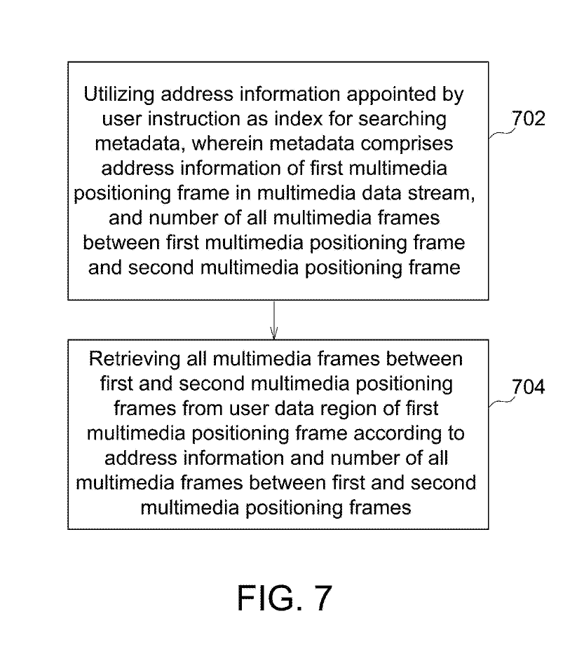

FIG. 7 shows a decoding method according to an embodiment of the present invention. The decoding method comprises the following steps.

In step S702, address information appointed by a user instruction is utilized as an index for searching a metadata. The metadata comprises address information of a first multimedia positioning frame in an encoded multimedia data stream, and the number of all multimedia frames between the first multimedia positioning frame and a second multimedia positioning frame, wherein the first multimedia positioning frame and the second multimedia positioning frame are two successive neighboring multimedia positioning frames.

In step S704, according to the address information and the number of all the multimedia frames between the first multimedia positioning frame and the second multimedia positioning frame, all the multimedia frames between the first multimedia positioning frame and the second multimedia positioning frame are retrieved from a user data region of the first multimedia positioning frame.

The encoding method in FIG. 6 and the decoding method in FIG. 7 summarize the main technical characteristics of the embodiments in FIGS. 2 to 5. It should be noted that, appropriate modifications and variations from the configurations and conditions of the encoding method in FIG. 6 and the decoding method in FIG. 7 are interpreted as embodiments of the present invention.

Thus, with the multimedia data stream format, the metadata generator, the encoding method, the encoding system, the decoding method and the decoding system disclosed in the above embodiments of the present invention, the data size of the metadata in the multimedia data stream may be significantly decreased. Further, when download and playback of a specific time point appointed by a user instruction are desired, the download waiting time for the multimedia frames and the number of times for searching the multimedia frames can be reduced.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An encoded multimedia data stream format, comprising:
a plurality of multimedia positioning frames, each comprising
a basic multimedia frame, and
a user data region for storing a plurality of multimedia frames following the basic multimedia frame in a multimedia data stream; and
a metadata, storing a plurality of address information and numbers of multimedia frames stored in the user data region corresponding to the multimedia positioning frames.

2. The multimedia data stream format according to claim 1, wherein when the metadata is read and one of the multimedia positioning frames is searched according to the address information stored in the metadata, the multimedia frames stored in the user data region of the multimedia positioning frame are read, and the multimedia frames are played following the basic multimedia frame.

3. The multimedia data stream format according to claim 1, wherein the user data region further comprises a LUT for storing a regional address and a length of the multimedia frames.

4. The multimedia data stream format according to claim 3, wherein when the encoded multimedia data stream is decoded, the multimedia frames are retrieved according the metadata and the LUT.

5. A multimedia data stream encoding system, comprising:
a multiplexer, for performing bit interleaving on an audio bitstream and a video bitstream to generate a multimedia data stream; and
a metadata generator, for selecting a plurality of multimedia frames in a multimedia data stream as a plurality of multimedia positioning frames, and generating a metadata according to address information of the multimedia positioning frames and numbers of multimedia frames between two successive multimedia positioning frames of the multimedia positioning frames; and
a multimedia data encoder, for relocating the multimedia frames between two successive neighboring multimedia positioning frames to a user data region of corresponding multimedia positioning frames according to the metadata to generate an encoded multimedia data stream.

6. The multimedia data stream encoding system according to claim 5, wherein the metadata generator further comprising:
a buffer, for storing the multimedia data stream.

7. The multimedia data stream encoding system according to claim 6, wherein the user data region further comprises a LUT storing the address information and a length of the multimedia frames.

8. A multimedia data stream decoding system for decoding an encoded multimedia data stream, comprising:
a multimedia data stream decoder, for searching a metadata according to an instruction to find addresses and numbers of multimedia frames of at least one multimedia positioning frame, and retrieving at least one multimedia frames from the at least one multimedia positioning frame according to the addresses and numbers of multimedia frames; and
a demultiplexer, for performing bit interleaving on the at least one multimedia frames to generate an audio bitstream and a video bitstream.

9. The multimedia data stream decoding system according to claim 8, wherein the multimedia positioning frame comprising a basic multimedia frame and a user data region, and the user data region for storing the at least one multimedia frames.

10. The multimedia data stream decoding system according to claim 9, wherein the user data region further comprises a LUT for storing a regional address and a length of the multimedia frames.

11. The multimedia data stream decoding system according to claim 10, wherein the multimedia data stream decoder retrieving at least one multimedia frames from the at least one multimedia positioning frame further according to the regional address and the length of the multimedia frames.

12. The multimedia data stream decoding system according to claim 9, wherein the metadata storing a plurality of address information and number of multimedia frames stored in the user data region of all multimedia positioning frames.
